(19) United States
(12) Patent Application Publication
(10) Pub. No.: US 2011/0029432 A1
(43) Pub. Date: Feb. 3, 2011

(54) COMPUTER-IMPLEMENTED METHODS OF PROCESSING PAYMENTS FOR A MERCHANT SELLING GOODS OR SERVICES TO A CONSUMER

(76) Inventor: Richard N. Hildred, Waterloo (CA)

Correspondence Address: PAUL W. MARTIN, NCR CORPORATION, LAW DEPT., 3097 SATELLITE BLVD., 2nd FLOOR, DULUTH, GA, 30096, US

(21) Appl. No.: 12/512,340

(22) Filed: Jul. 30, 2009

(51) Int. Cl. G06Q 40/00; G06Q 20/00

(52) U.S. Cl. 705/40; 705/30

(57) ABSTRACT

A computer-implemented method is provided of processing payments to a merchant for selling goods or services to a consumer. The computer-implemented method comprises at a first time, receiving from the consumer a first payment made by a first payment instrument for a first purchase of goods or services, at a second time which is after the first time, receiving from the consumer a second payment made by a second payment instrument which is different from the first payment instrument for a second purchase of goods or services, and processing the first and second payment instruments to link the first and second payment instruments to the same consumer and thereby allowing the merchant to link the first and second purchases of goods or services without having had to ask the consumer for any personal information.

### BACKGROUND OF THE INVENTION

The present invention relates to commercial transactions between a merchant and a consumer, and is particularly directed to computer-implemented methods of processing payments for a merchant selling goods or services to a consumer.

In a typical commercial transaction between a consumer and a merchant selling goods or services, the consumer makes payment to the seller using a payment method which is supported by the merchant. Examples of payment methods include credit card, debit card, smart card, or check. The merchant usually supports a number of different payment methods used by their consumers.

The consumer may use a first payment method when goods or services are purchased in a first transaction with the merchant. Then, at a later time, the consumer may use a second payment method which is different from the first payment method when goods or services are purchases in second transaction with the merchant. In some situations, such as during a merchant marketing campaign, it may be desirable for the merchant to be able to identify that the consumer in the first transaction and the consumer in the second transaction are the same person, even though the consumer used different payment methods in the transactions.

### SUMMARY OF THE INVENTION

In accordance with one embodiment of the present invention, a computer-implemented method is provided of processing payments to a merchant for selling goods or services to a consumer. The computer-implemented method comprises at a first time, receiving from the consumer a first payment made by a first payment instrument for a first purchase of goods or services, at a second time which is after the first time, receiving from the consumer a second payment made by a second payment instrument which is different from the first payment instrument for a second purchase of goods or services, and processing the first and second payment instruments to link the first and second payment instruments to the same consumer and thereby allowing the merchant to link the first and second purchases of goods or services without having had to ask the consumer for any personal information.

### BRIEF DESCRIPTION OF THE DRAWINGS

In the accompanying drawings:

FIG. 1 is a schematic diagram of a merchant receiving a payment from a consumer for a purchase of goods or services from the merchant;

FIG. 2 is a schematic diagram of the merchant of FIG. 1 receiving another payment from the consumer for another purchase of goods or services from the merchant; and

FIG. 3 is a flowchart depicting a computer-implemented process associated with the schematic diagrams of FIGS. 1 and 2.

### DETAILS OF THE INVENTION

The present invention relates to commercial transactions between a merchant and a consumer, and is particularly directed to computer-implemented methods of processing payments for a merchant selling goods or services to a consumer.

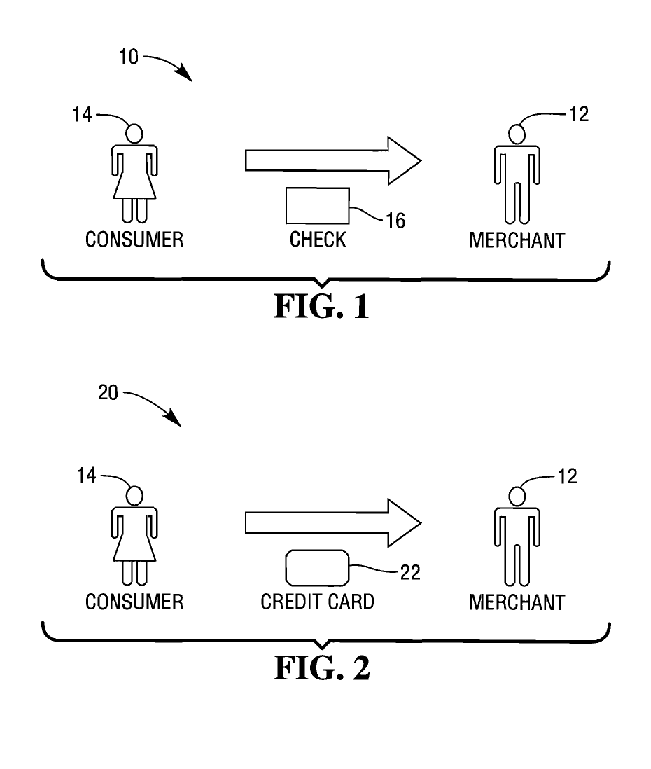

Referring to FIG. 1, a schematic diagram of a first commercial transaction 10 between a merchant 12 and the consumer 14 is illustrated. During the first commercial transaction 10, the consumer 14 purchases goods or services (not shown) from the merchant 12. The consumer 14 makes payment to the merchant 12 for the goods or services purchased during the first commercial transaction 10 using a first payment instrument in the form of a check 16.

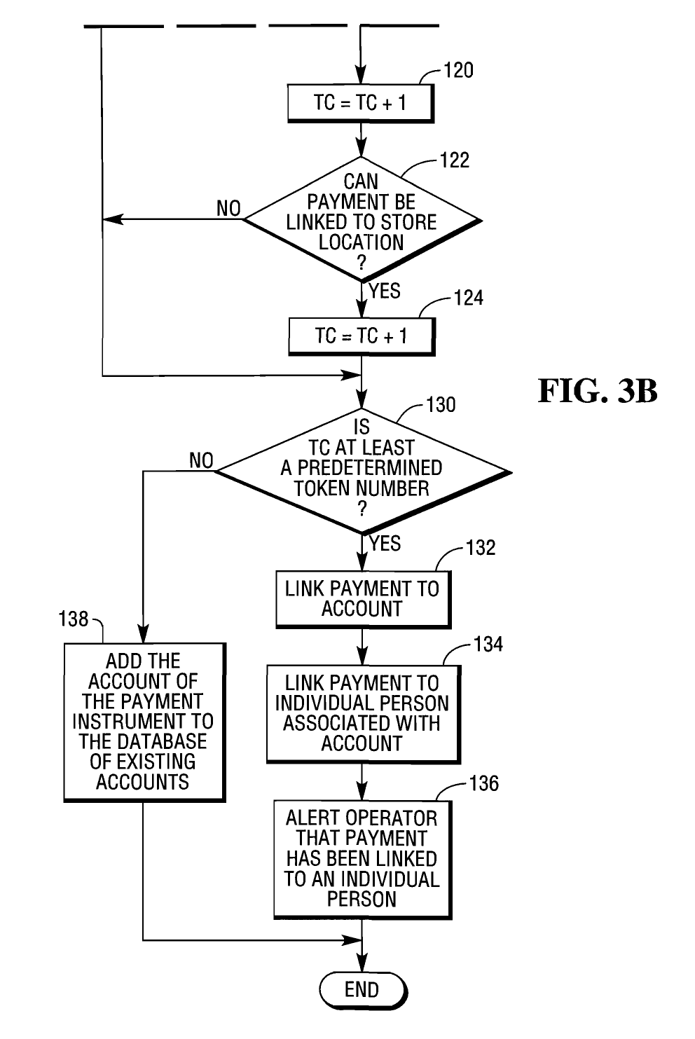

Referring to FIG. 3, a flowchart 100 depicts a computer-implemented process associated with the first commercial transaction 10 illustrated in the schematic diagram of FIG. 1. The computer-implemented process 100 may be carried by a merchant server or microcomputer (both not shown). Suitable servers and microcomputers are readily available in the marketplace and, therefore, will not be described.

After the merchant server receives the check 16 from the consumer 14 in the first commercial transaction 10 of FIG. 1 (step 102), a name and address contained in a payor field of the check is parsed and split into an array of “words” (step 104). The “words” are then separated apart from each other using punctuation and whitespace as required (step 106). For each “word”, a one-way encryption is performed to provide an encrypted value which is stored in memory (step 108). The encrypted values of the array of “words” stored in memory are associated with an individual person (step 110). A token counter (“TC”) is initialized and set to a value of zero (step 112).

A determination is made in step 114 as to whether the first payment instrument (i.e., the check 16 in FIG. 1) can be linked to an existing account already stored in memory. More specifically, the determination is made based upon a comparison of the name of the individual person (as identified in step 110) with name of an individual person for each existing account stored in memory. If the determination in step 114 is affirmative (i.e., the check 16 can be linked to an existing account stored in memory), then the TC is incremented by a value of one (step 116). However, if the determination in step 114 is negative (i.e., the check 16 cannot be linked to an existing account stored in memory), then the process proceeds to step 130 to be described in detail later.

After the TC is incremented by a value of one in step 116, a determination is made step 118 as to whether the first financial instrument (i.e., the check 16 in FIG. 1) can be linked to another financial instrument with the same payee name. If the determination in step 118 is affirmative (i.e., the check 16 has a payee name which can be linked to a payee name of another financial instrument), then the TC is incremented by another value of one (step 120). However, if the determination in step 118 is negative (i.e., the check 16 has a payee name which cannot be linked to a payee name of another financial instrument), then the process proceeds to step 130 to be described in detail later.

After the TC is incremented by a value of one in step 120, a determination is made in step 122 as to whether the check 16 in FIG. 1 has a payee name which can be linked to a particular store location at which the same payee name has previously made a payment. If the determination in step 122 is affirmative (i.e., the check 16 has a payee name which can be linked to particular store location), then the TC is incremented by another value of one (step 124). However, if the determination in step 122 is negative (i.e., the check 16 has a payee name which cannot be linked to a particular store location), then the process proceeds to step 130.

In step 130, a determination is made as to whether the most recent value of TC is at least a predetermined number. If the determination in step 130 is negative (i.e., the value of TC is not at least the predetermined number), then the individual person who is associated with the account of the payor of the payment instrument which was received back in step 102 is now added as a new person to the database of existing accounts (step 138). However, if the determination in step 130 is affirmative (i.e., the value of TC is at least the predetermined number), then the payment by the check 16 is linked to a specific account stored in memory (step 132). The payment by the check 16 is then linked via the account to an individual person associated with the particular account (step 134). An operator is then alerted that the payment the check 16 has been linked a specific individual person associated with the particular account (136).

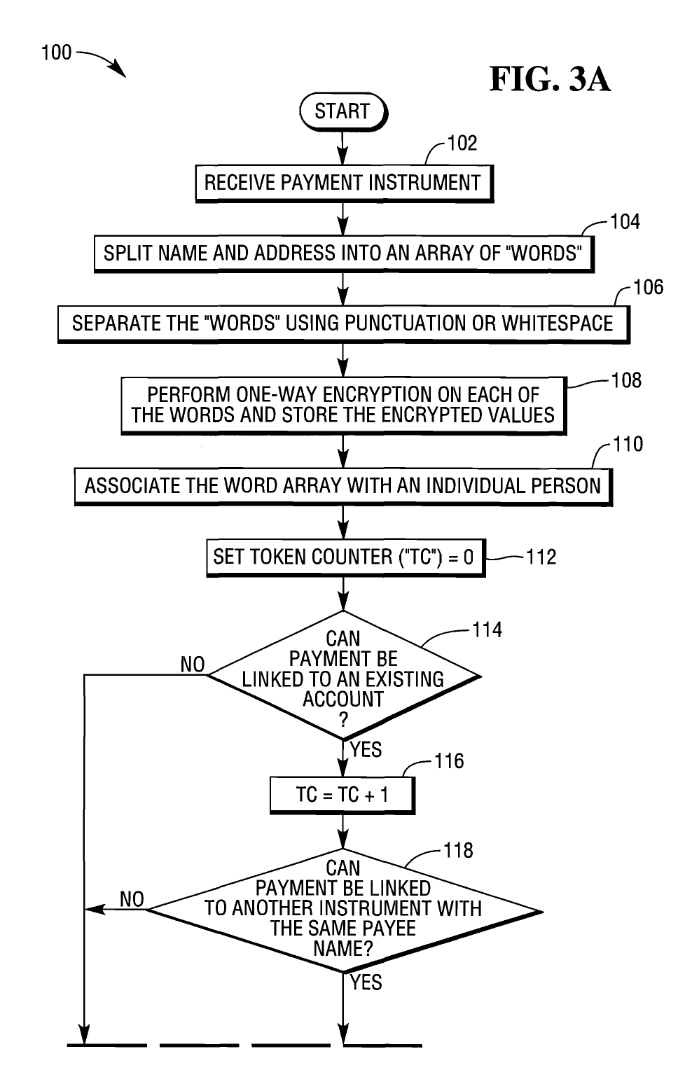

Referring to FIG. 2, a second commercial transaction 20 between the merchant 12 and a consumer 14 is illustrated. The second commercial transaction 20 is different from the first commercial transaction 10, and takes place after the first commercial transaction 10. During the second commercial transaction 20, the consumer 14 purchases other goods or services (not shown) from the merchant 12. The consumer 14 makes payment to the merchant 12 for the goods or services purchased during the second commercial transaction 20 using a second payment instrument in the form of a credit card 22. The second payment instrument 22 (i.e., the credit card in this example) is different from the first payment instrument 16 (i.e., the check).

Payment information obtained from the credit card 22 is then processed through the same computer-implemented process shown in FIG. 3 and previously described with respect to the check 16 in the first commercial transaction of FIG. 1. In this example, the payment information from the credit card 22 of FIG. 2 is processed such that it is linked to the payment information which was previously processed for the check 16 of FIG. 1. This link is established in steps 114, 118, 122 shown in the flowchart 100 of FIG. 3.

It should be apparent that the payment information obtained from the check 16 and the payment information obtained from the credit card 22 are most likely linked by way of matching of the encrypted word values of the first and last names (and possibly also the middle initial) appearing on both payment instruments. Since a billing address is usually not included on the magnetic stripe of the credit card 22, a link by way of matching addresses between the payment instruments is unlikely.

If there is also a match between the store location at which check 16 was paid and the store location at which credit card 18 was swiped, then this match increases the likelihood that the match between the first and last names is from the same individual person. This is especially useful in instances where the first and last names being compared are common names like “John Smith” for example.

It should also be apparent that the more encrypted word values that can be matched between the payment instruments, the more likely that the two payment instruments will be correctly linked to each other in the manner as described hereinabove. Accordingly, encrypted word values of payment information which is other than first and last names, addresses, and store locations may be processed to determine if there is a match.

It should be noted that the use of the TC allows a probable match to be found. This probable match is predicated upon what may be a match on less than the complete set of tokens available. In the particular process shown in the flowchart 100 of FIG. 3, the complete set of tokens available comprises the three determination steps of 114, 118, and 122.

As an example, if the predetermined token number (as shown and described with respect to step 130 shown in FIG. 3) is equal to “three”, then it should be apparent that all three determinations in steps 114, 118, 122 need to be affirmative before the payment is linked to an individual person. However, if the predetermined token number is equal to “two”, then it should be apparent that only two of the three determinations in steps 114, 118, 122 need to be affirmative before the payment is linked to an individual person. Similarly, if the predetermined token number is equal to “one”, then it should be apparent that only one of the three determinations in steps 114, 118, 122 need to be affirmative before the payment is linked to an individual person.

Accordingly, in the example situation just described, it should be apparent that a human operator can setup a “probable match” by setting the predetermined token number equal to “one”, “two”, or “three”. The probability of a match when the predetermined token number is set equal to “three” is greater than the probability of a match when the predetermined token number is set equal to “two”. Thus, the probability of a match when the predetermined token number is equal to “three” is greater than the probability of a match when the predetermined token number is set equal to “one”.

Although the above description describes only three criteria by which the probability of a match between the first and second payment instruments is made, it is conceivable that the number of criteria required for a probable match may be any number of criteria. Moreover, although the above description describes three specific types of criteria (i.e., existing account number, payee name, and store location), it is conceivable that other types of criteria may be used in addition to or in place of these criteria.

A number of advantages may result by linking the credit card 22 payment of FIG. 3 with the check 16 payment of FIG. 1 in the manner as described hereinabove. One advantage is that the merchant is able to identify a single individual person amongst a plurality of commercial transactions even though this person used a different payment instrument in each of the plurality of transactions. Moreover, the merchant is provided with this knowledge of about the person without having to ask the person for any personal information during any of the commercial transactions. This knowledge about the person may enable the merchant to custom design a marketing campaign targeted specifically for this person.

Another advantage is that the merchant has an opportunity to link an individual person to their purchasing habits since the merchant would also know what specific products the person has purchased in previous purchases regardless of the payment method or channel used.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A computer-implemented method of processing payments to a merchant for selling goods or services to a consumer, the computer-implemented method comprising:
at a first time, receiving from the consumer a first payment made by a first payment instrument for a first purchase of goods or services;
at a second time which is after the first time, receiving from the consumer a second payment made by a second payment instrument which is different from the first payment instrument for a second purchase of goods or services; and
processing the first and second payment instruments to link the first and second payment instruments to the same consumer and thereby allowing the merchant to link the first and second purchases of goods or services without having had to ask the consumer for any personal information.

2. A computer-implemented method according to claim 1, wherein the second payment instrument is linked to the first payment instrument by way of an existing account stored in memory and associated with the first payment instrument.

3. A computer-implemented method according to claim 1, wherein the second payment instrument is linked to the first payment instrument by way of first and last names of the consumer stored in memory and associated with the first payment instrument.

4. A computer-implemented method according to claim 1, wherein the second payment instrument is linked to the first payment instrument by way of a store location stored in memory and associated with the first payment instrument.

5. A computer-implemented method according to claim 1, wherein the second payment instrument is linked to the first payment instrument only when at least a predetermined number of criteria associated with the second payment instrument has been stored in memory and has been associated with the first payment instrument.

6. A computer-implemented method of processing payments to a merchant for selling goods or services to a consumer, the computer-implemented method comprising:
at a first time, receiving from the consumer a first payment made by a first payment instrument for a first purchase of goods or services;
at a second time which is after the first time, receiving from the consumer a second payment made by a second payment instrument which is different from the first payment instrument for a second purchase of goods or services; and
processing the first and second payment instruments to link the first and second payment instruments to the same consumer and thereby allowing the merchant to link the first and second purchases of goods or services without having had to ask the consumer for any personal information, wherein the second payment instrument is linked to the first payment instrument only when at least a predetermined number of criteria associated with the second payment instrument has been stored in memory and has been associated with the first payment instrument.

7. A computer-implemented method according to claim 6, wherein the second payment instrument is linked to the first payment instrument by way of an existing account stored in memory and associated with the first payment instrument.

8. A computer-implemented method according to claim 6, wherein the second payment instrument is linked to the first payment instrument by way of first and last names of the consumer stored in memory and associated with the first payment instrument.

9. A computer-implemented method according to claim 6, wherein the second payment instrument is linked to the first payment instrument by way of a store location stored in memory and associated with the first payment instrument.
